(19) United States
(12) Patent Application Publication
(10) Pub. No.: US 2021/0203203 A1
(43) Pub. Date: Jul. 1, 2021

(54) ROTOR AND MACHINE WITH A CYLINDRICAL CARRYING BODY

(71) Applicant: Siemens Aktiengesellschaft, Munich (DE)

(72) Inventors: Michael Frank, Uttenreuth (DE); Jörn Grundmann, Großenseebach, Bayern (DE); Johannes Richter, Fürth (DE); Peter van Hasselt, Erlangen (DE)

(73) Assignee: Siemens Aktiengesellschaft, Munich (DE)

(21) Appl. No.: 17/057,653

(22) PCT Filed: May 6, 2019
(86) PCT No.: PCT/EP2019/061486

§ 371 Date: Nov. 21, 2020

(30) Foreign Application Priority Data
May 28, 2018 (DE) 10 2018 208 368.1

(51) Int. Cl. H02K 3/24; H02K 1/24; H02K 1/32; H02K 9/197; H02K 55/02

(52) U.S. Cl. CPC H02K 3/24; H02K 1/24; H02K 2213/03; H02K 9/197; H02K 55/02; H02K 1/32

(57) ABSTRACT

A rotor for an electrical machine with a central rotor axis, the rotor includes at least one superconducting coil arrangement, a cooling system for cooling the coil arrangement to a cryogenic operating temperature, and a carrying body which mechanically carries at least one coil arrangement from a radially inner side of the coil arrangement. The carrying body has a substantially cylindrical outer contour. The carrying body is predominantly composed of an amagnetic material which has a density of at most 4.6 g/cm3 and a thermal conductivity of at least 10 W/(m-K). The carrying body is designed to thermally couple the superconducting coil arrangement to the cooling system. An electrical machine has a rotor of this kind.

### CROSS REFERENCE TO RELATED APPLICATIONS

This application is the US National Stage of International Application No. PCT/EP2019/061486 filed 6 May 2019, and claims the benefit thereof. The International Application claims the benefit of German Application No. DE 10 2018 208 368.1 filed 28 May 2018. All of the applications are incorporated by reference herein in their entirety.

### FIELD OF INVENTION

The present invention relates to a rotor for an electric machine having a central rotor axis A, comprising at least one superconducting coil assembly, a cooling system for cooling the coil assembly to a cryogenic operating temperature, and a carrying body which from a radially inward side of the coil assembly mechanically supports the at least one coil assembly, wherein the carrying body has a substantially cylindrical external contour. The invention furthermore relates to an electric machine having a rotor of this type.

### BACKGROUND OF INVENTION

According to the prior art, the superconducting coil assemblies in superconducting rotors are typically held on inward cylindrical carrying bodies, wherein these carrying bodies fulfil a plurality of functions simultaneously. On the one hand, the carrying body serves for mechanically mounting the coil assemblies. On the other hand, the carrying body in most instances also effects the thermal coupling of the superconducting coil assemblies to a cooling system so as to cool the superconducting conductor to a cryogenic operating temperature below the transition temperature of the superconductor. Thirdly, the carrying body (or at least parts thereof) also fulfil(s) the function of guiding the magnetic flux. To this end, substantial parts of the carrying body are typically configured from ferromagnetic material. In order for all functions mentioned to be able to be simultaneously fulfilled, such a carrying body according to the prior art typically has a relatively complex structure in which elements of iron (for guiding the magnetic flux) as well as elements of copper (for thermal coupling) are mechanically connected to one another in a fixed manner. Since very high temperature differentials have to be overcome when cooling the rotor from room temperature to a cryogenic operating temperature, it is also important in the case of this complex structure that a stable mechanical adhesion of the individual components is guaranteed also in view of the dissimilar thermal contraction of the different materials. A very high level of complexity in the basic design of such a rotor results on account thereof. A further disadvantage of known rotors of this type is the great weight of the latter, since the two important structural materials iron and copper have in each case a comparatively high density. In order for the functions of guiding the magnetic flux of the iron yoke and thermally coupling the coils by means of a cooling bus structure of copper that is incorporated in the yoke to be guaranteed, relatively large quantities of said materials are simultaneously required. Apart from the high level of complexity, a great overall mass of the rotor also results therefrom specifically in rotors and rotating machines with a relatively large diameter.

### SUMMARY OF INVENTION

It is therefore the object of the invention to specify a rotor which overcomes the disadvantages mentioned. In particular, a rotor which has a comparatively simple construction of the carrying body that supports the coil assembly/assemblies is to be made available. The carrying body herein is to meet the requirements in terms of the mechanical stability for the mounting of the coil assembly/assemblies and the thermal coupling for cooling the coil assembly/assemblies. At the same time, a sufficient magnetic flux chain between the rotor and the stator is to be guaranteed herein. In particular, the rotor is to be configured so as to be as light as possible. It is a further object to specify an electric machine having the mentioned properties.

These objects are achieved by the rotor and by the electric machine described herein.

The rotor according to the invention is a rotor for an electric machine having a central rotor axis A. The rotor comprises at least one superconducting coil assembly. Said rotor furthermore comprises a cooling system for cooling the coil assembly to a cryogenic operating temperature. Said rotor furthermore comprises a carrying body which from a radially inward side of the coil assembly mechanically supports the at least one coil assembly. The carrying body herein has a substantially cylindrical external contour. The carrying body is composed largely of a non-magnetic material which has a density of at most 4.6 g/cm³ and a thermal conductivity of at least 10 W/(m·K). The carrying body is furthermore designed for thermally coupling the superconducting coil assembly to the cooling system.

In other words, the cylindrical carrying body as the primary component part is to comprise the mentioned non-magnetic material having the stated properties. For example, this mentioned non-magnetic material can account for more than half of the solid volume of the carrying body. Alternatively or additionally, the mentioned non-magnetic material can also account for more than half of the mass of the carrying body. In principle, it is not to be excluded herein that one or a plurality of other materials having deviating properties are present as a secondary component part in the carrying body.

The mentioned non-magnetic material having the stated properties can itself be either a homogenous material, or said non-magnetic material can alternatively also be a composite material of which the sum of properties is intended to meet the mentioned properties in terms of magnetizability, density, and thermal conductivity. In other words, in such a case these are to be the effective properties of the entire composite material, for example the effective thermal conductivity and the mean density.

The cooling system in general is to be designed for cooling the at least one superconducting coil assembly to the cryogenic operating temperature. To this end, the cooling system can comprise a coolant duct for circulating a cryogenic fluid coolant, for example. This herein can be an overall closed coolant circuit, wherein however not all parts of this circuit have to be disposed in the region of the rotor but specific parts, such as a cryo-cooler and an external coolant in feedline, can also be disposed in the stationary regions of the electric machine. In terms of the cooling system of the rotor it is essential merely that overall there are structures by way of which sufficient thermal coupling of the coil installation(s) to a cold region of the rotor (thus to a coolant transported in a coolant duct, for example) is guaranteed such that the coil assembly/assemblies can be operated in the superconducting state.

In the context of the present invention it is essential that the carrying body per se is designed for thermally coupling the superconducting coil assembly to the cooling system. In particular, the carrying body can represent the substantially effective thermal path between the coil assembly and the cooling system, thus between the coil assembly and a coolant duct which is embedded in the carrying body, for example. In order for this to be enabled, the mentioned non-magnetic material of the carrying body is to have a sufficiently high thermal conductivity in the mentioned range of values.

The cylindrical carrying body, or the substantially cylindrical external contour of this carrying body, respectively, is to be understood such that the encasing shape of the carrying body is cylindrical. This encasing shape can in particular have a circular-cylindrical geometry. It is however not to be excluded in principle herein that slight deviations from this circular-cylindrical casing result locally on the external face of the carrying body; for example, the carrying body can have one or a plurality of recesses, in particular in the form of flat spots by way of which the bearing faces for mechanically mounting the coil assembly/assemblies are defined. Alternatively or additionally, the carrying body on the external face thereof can also have one or a plurality of protrusions, for example, so as to fill the coil assembly/assemblies in the center of the respective coil.

The core concept of the present invention in superconducting coil assemblies, by virtue of the high current-carrying capability of said superconducting coil assemblies, lies in being able to dispense with structures that guide the magnetic flux in the region of the carrying body provided the conductor cross section is sufficiently large. A secondary component part of the carrying body that guides the magnetic flux herein, for example in the form of comparatively small individual structural elements, is not to be excluded in principle. It is essential that the primary component part of the carrying body is formed from a non-magnetic material. The invention is thus based on the concept that it is better in certain circumstances for the guiding of flux through the carrying body to be (at least largely) dispensed with and to instead achieve a sufficiently strong chain of flux between the rotor and the stator by way of a comparatively high current-carrying capability of the coil assembly. This can be achieved, for example, by way of a comparatively large material cross section of the superconducting conductor within the coil assembly and/or a high current density in the conductor material per se. Overall, the coil assembly can thus be operated at a comparatively high operating current, whereby properties of the carrying body in terms of guiding the magnetic flux can at least largely be dispensed with.

On account of the choice of a non-magnetic primary component part for the material of the carrying body it becomes possible for the carrying body to be designed with a mean density which is substantially less than the density of iron. A comparatively light rotor can thus be implemented on account of the choice of such a light material having a density in the mentioned range of values. Additional heavy structures for thermally coupling the coil assembly/assemblies (in particular a complex cooling bus made of copper) can also be dispensed with since the primary component part of the carrying body itself is to have a comparatively high thermal conductivity in the mentioned range. On account thereof, efficient cooling by way of a tight thermal coupling of the coil assembly/assemblies to a coolant duct which is embedded in the carrying body can be guaranteed.

Overall, a rotor in which the carrying body fulfils simultaneously the requirements for mechanically mounting the coil assembly/coil assemblies and for cooling the latter can thus be made available, wherein the carrying body nevertheless is of a comparatively simple construction. In particular, the carrying body can be assembled from a lesser number of individual sub-elements than in the prior art. Furthermore, the carrying body and thus also the entire rotor can be of a comparatively light configuration.

The electric machine according to the invention comprises a rotor according to the invention and a stator which is disposed so as to be stationary. The rotor herein can in particular be mounted so as to be rotatable about the central rotor axis A. The advantages of the machine according to the invention are derived in a manner analogous to that of the above-stated advantages of the rotor according to the invention.

Advantageous design embodiments and refinements of the invention are derived from the dependent claims and from the description hereunder. The described design embodiments of the rotor and of the electric machine herein can in general be advantageously combined with one another.

In a generally advantageous manner, the density of the non-magnetic primary component part of the carrying body can be restricted to a mean value of 3 g/cm³ or less.

According to one particularly advantageous embodiment, the non-magnetic material of the carrying body can comprise aluminum. In particular, this non-magnetic primary component part of the carrying body can either be formed substantially by aluminum per se or by an aluminum-containing alloy. Aluminum is particularly suitable for fulfilling the mentioned requirements in terms of density and thermal conductivity and for simultaneously guaranteeing a high mechanical strength even at low temperatures. In this embodiment, the aluminum or the aluminum alloy does however also not need to be the single material component part of the carrying body. For example, a further material which imparts to the carrying body additional advantageous properties can be embedded in a load-bearing basic structure of aluminum, or an aluminum alloy, respectively, in the manner of a lattice structure. This additional material can be a material which has an even better thermal conductivity, for example, and/or a material which is even lighter. Alternatively or additionally, such an embedded material can also be a secondary component part of the carrying body that does not fulfill the material requirements mentioned further above. This herein can in particular also be a material which guides the magnetic flux and in the form of one or a plurality of additional elements is present within the support structure formed by the primary component part. Moreover, the described embodiment of the carrying body having a lattice-type composition from a support structure and a filler is not limited to the choice of aluminum as the non-magnetic primary component part but can in general also be used in combination with other load-bearing materials.

As an alternative to the choice of aluminum or an aluminum alloy as the non-magnetic component part of the carrying body, the latter can also comprise a fiber-composite material. Such a fiber-composite material can either itself form the primary component part of the carrying body, or else said fiber-composite material as an additional filler can be embedded in a load-bearing structure from another material. For example, a mechanically load-bearing structure from an aluminum-containing material can be filled with individual elements from fiber-composite material. Conversely, a mechanically load-bearing structure from a fiber-composite material can however also be filled with individual elements from an aluminum-containing material, for example so as to increase the effective thermal conductivity of the entire carrying body as compared to a pure fiber-composite material. In such an embodiment, a metallic element (or a plurality of the latter) for facilitating the thermal coupling can be provided within a fiber-composite material in the region between an embedded coolant duct and an externally bearing coil assembly, for example. Alternatively or additionally however, such a fiber-composite material can also be provided with a finely distributed metallic filler material so as to increase the overall thermal conductivity of the fiber-composite material.

The carrying body in general when operating the rotor can be designed to be at a cryogenic operating temperature. Such a cryogenic operating temperature is intended to be understood to be a temperature below 77 K and/or a temperature below the transition temperature of the superconductor. Such a “cold” operation of the carrying body advantageously enables a thermal coupling of the coil assembly/assemblies to the cooling system to be facilitated by the material of the carrying body.

In a generally advantageous manner, and independently of the specific embodiment and choice of material, the carrying body can comprise at least one coolant duct embedded in the former for transporting a fluid coolant. In particular, the carrying body (or a sub-element thereof) can have a basic structure in the shape of a cylindrical shell, and the at least one coolant duct can thus be embedded in this cylinder shell so that fluid coolant by way of this duct can be directed to the proximity of the superconducting coil assembly. To this end, the smallest spacing between the coil assembly and the coolant duct embedded in the carrying body can in a generally advantageous manner be 10 mm or even less. Relevant for the thermal coupling of the coil assembly to the coolant in this instance is in particular the effective thermal conductivity of that material that configures the carrying body in the region between the duct and the coil assembly.

The carrying body can particularly advantageously have a plurality of duct segments which are configured for enabling a parallel flow of coolant through the individual duct segments. This is particularly advantageous for thermally coupling in each case a plurality of coil assemblies tightly to the cooling system. However, even in the case of a single coil assembly it can already be expedient for the individual regions of the coil (in particular individual coil limbs) to be in each case cooled by way of one or a plurality of dedicated duct segments. It is overall advantageous for the number of duct segments to correspond to at least the number of the individual coil assemblies and to in particular form an integer multiple of said number of individual coil assemblies.

The mentioned individual duct segments can in particular be axially running duct segments which can in particular run at a minor spacing beside individual axial coil limbs in order for the heat of the latter to be efficiently dissipated. Alternatively or additionally to the mentioned axial duct segments, one or a plurality of radial duct segments can however also be present, for example for conducting liquid cryogenic coolant from a central inflow in the proximity of the rotor axis A into the regions which are close to the individual coil assemblies and lie further outward in radial terms (and optionally for directing said coolant from there back into the region of an outflow in the region of the rotor axis, said outflow potentially being identical to the inflow or else being separately embodied). Alternatively or additionally to the mentioned axial and/or radial duct segments, one or a plurality of duct segments which are configured so as to be annular and extend in the circumferential direction of the rotor can also be present. On account thereof, a uniform distribution of the coolant across the circumference of the rotor can be achieved.

A cage-type duct structure by means of which coolant can advantageously be transported to many individual locations in the proximity of the respective coil assemblies can be formed when the overall duct structure is assembled in the manner described from individual axial segments and/or radial segments and/or circumferential segments. Either all duct segments herein, or else only parts of these duct segments, can advantageously be embedded in the cylindrical carrying body.

Overall, the superordinate duct system in general can advantageously and independently of the specific construction be configured for circulating the cryogenic coolant according to the thermosiphon principle.

The fluid (thus the liquid or gaseous, respectively) coolant can in particular be liquid hydrogen, liquid helium, liquid neon, liquid nitrogen, liquid oxygen, and/or liquid methane. When all these cryogenic coolants are used, the liquid form as well as the gaseous form can be present, and an additional cooling effect can be achieved by a evaporating the liquid in the region of the components to be cooled. In the context of the present invention, neon and hydrogen are particularly advantageous as fluid coolants in order to achieve very low operating temperatures, wherein the cooling is nevertheless relatively cost-effective.

In a generally advantageous manner, the carrying body in the region of the cylindrical external contour thereof can be designed so as to be fluid-tight. In other words, the carrying body can have a fluid-tight external face in the manner of a cylindrical shell, said external face being in particular tight in relation to the fluid coolant used. Alternatively or additionally, the mentioned fluid-tight external face can also be embodied so as to be vacuum-tight. The external side of the carrying body in the region of the entire cylinder shell is particularly advantageously configured so as to be fluid-tight throughout. The axial end regions may however be open since the carrying body here can in principle be sealed using additional elements. In the context of this embodiment it is only essential that the outward cylinder shell is fluid-tight so as to enable reliable separation between the coolant chamber, which runs within the carrying body, and an outward region of the carrying body. In particular, a vacuum chamber which can guarantee the thermal insulation of the rotor in relation to an outer stator can be provided so as to be radially outside the carrying body. A vacuum-tight and fluid-tight separation of the coolant chamber and the vacuum chamber is important above all in the case of this embodiment. This separation can be expediently guaranteed by way of the outer cylinder wall of the carrying body. Alternatively however, it is in principle also possible for the carrying body to be embodied so as not to be absolutely tight. In this case, additional vacuum-tight sealing can be achieved by a radially external casing, for example. Such a casing can radially surround the carrying body as well as the coil assembly/assemblies and separate the region of the rotor from the external vacuum chamber.

According to a generally particularly advantageous embodiment, the carrying body can have an inner cylinder and an outer cylinder, wherein the outer cylinder radially surrounds the inner cylinder and on the external side of the former mechanically supports the at least one coil assembly. In other words, the carrying body in this instance is assembled at least from these two individual cylindrical elements, wherein the two individual elements are present as separately produced components. These cylinders which are nested inside one another can be subsequently connected to one another, for example by welding and/or by screw-fitting and/or by adhesive bonding and/or by a form-fit (for instance by means of mutually engaging dovetails of other types of meshing teeth). In this embodiment, the inner cylinder as well as the outer cylinder as a primary component part expediently comprise a non-magnetic material having the properties mentioned further above. The materials for the inner cylinder and the outer cylinder herein can in principle be chosen in a mutually independent manner. However, the inner cylinder and the outer cylinder are particularly advantageously formed from the same material or the same materials, wherein either a homogenous material or else a material composite can in each case be chosen.

A coolant duct can in this instance be particularly advantageously configured in the contact region formed between the inner cylinder and the outer cylinder. This coolant duct can be formed, for example, by a corresponding elongate recess in the inner cylinder and/or in the outer cylinder. The design embodiment of the carrying body having two cylinders which are nested inside one another thus enables in a particularly simple manner the configuration of a coolant duct and in particular of a cooling system from a plurality of individual duct segments. In particular, duct segments in the axial direction and/or annular duct segments in the circumferential direction can be configured in a comparatively simple manner in the contact region of the two cylinders. A relatively complex superordinate duct structure, for example in the form of a cage structure, can thus be formed in a simple manner by configuring a plurality of axial segments and/or circumferential segments.

In principle, the carrying body of the rotor can be made by means of an additive manufacturing method. Such additive manufacturing methods enable in a simple manner the production of complex geometric structures which can be assembled from dissimilar materials, for example, and can also have internal recesses (for example in the form of a duct system). The additive manufacturing thus represents a further simple possibility for generating a carrying body having an internal embedded duct structure. In this embodiment, the carrying body can correspondingly also be formed from a single radially continuous hollow cylindrical body. In principle however, it is also possible for the carrying body to be nevertheless constructed from two or more cylinders which are nested in one another, and for these prefabricated individual cylinders to be in each case manufactured by an additive method. In this way, lattice structures from dissimilar materials can also be implemented in the respective hollow cylinder (independently of whether this is an individual cylinder or a plurality of cylinders nested in one another).

In principle, the carrying body of the rotor can be formed exclusively from (one or a plurality of) non-magnetic materials. This is advantageous, for example, when the current-carrying capability of the coil assembly/assemblies is high such that no additional guiding of flux is required within the rotor.

However, in principle it is also possible, and advantageous under certain circumstances, for the carrying body in addition to the mentioned non-magnetic material to have a comparatively minor proportion of ferromagnetic material. Such a ferromagnetic material can configure one or a plurality of additional elements, for example, which are embedded in the non-magnetic basic structure or are disposed on an external side of this basic structure. In general, such additional ferromagnetic elements advantageously do not have to fulfil a substantial mechanical load-bearing function. Therefore, these ferromagnetic elements do not have to be mandatorily formed from a cryogenic material, this reducing the cost of said elements and facilitating the manufacturing of the latter.

For example, individual protrusions from ferromagnetic material can be configured on the radially external side of the cylindrical carrying body. These protrusions can be configured for filling the individual coil elements in the local centers thereof. Optionally, the protrusions from here can additionally mechanically support the coil elements; the mechanical stresses here are however comparatively minor, in particular in the case of low rotating speeds. In other words, in the case of a ferromagnetic embodiment of these protrusions, individual magnetizable pole cores are formed on a non-magnetic carrying body. In the presence of a plurality of superconducting coil assemblies in the rotor, it is advantageous herein for exactly one such pole core to be assigned to each coil assembly.

It is furthermore generally advantageous for the carrying body as a sub-face of the external face thereof to have at least one radially external bearing face on which the at least one coil assembly is mechanically held. The bearing face here is thus in particular a face which is oriented in a radially outward manner and which enables the mechanical mounting of the coil assembly by the carrying body as well as the thermal coupling for cooling the coil assembly. In particular, the carrying body in the region of this described bearing face can be formed from the mentioned non-magnetic material having the mentioned further properties in terms of density and thermal conductivity. The carrying body in the region of this described bearing face can particularly advantageously be designed so as to be free of copper. Furthermore, even the entire carrying body can be designed so as to be free of copper. In other words, by virtue of the advantages of the invention the copper cooling bus which is usual in the prior art can be dispensed with, since a sufficiently high thermal coupling to the cooling system (and in particular to a coolant duct embedded in the inside of the carrying body) can be achieved by way of the described basic material of the carrying body.

In a generally advantageous manner, the mentioned bearing face can be a flat bearing face. Such a flat bearing face can be configured, for example, by a flat stop in the external region of the cylindrical carrying body, said flat spot matching the base face of the coil assembly. In the case of a plurality of coil assemblies in the rotor, a correspondingly large number of such matching bearing faces can generally be configured on the carrying body.

A planar bearing face is particularly suitable for disposing a coil assembly having at least one planar first primary face. For example, the coil assembly can be a flat coil or a stack of flat coils. In the case of the embodiment having a stack of flat coils, this herein can be a stack of congruent flat coils of identical size. Alternatively however, it is also possible for the coil assembly to be formed as a stack of flat coils of variable size, so that a step-type profile is formed in particular on the radially external side of the coil assembly. Such a step-type profile can in particular be designed such that a circular-cylindrical encasing shape of the rotor is replicated.

In addition to the mentioned at least one radially outward orientated bearing face, the carrying body can optionally have one protrusion per coil assembly, said protrusion being in particular designed such that said protrusion as a coil core fills the local interior of the coil assembly. This coil core in a generally advantageous manner can also be formed from a non-magnetic material having the mentioned further properties. Alternatively however, it is also possible for this coil core to be formed from ferromagnetic material and as an additional element to sit on the otherwise in particular non-magnetic carrying body.

The rotor can generally particularly advantageously have a plurality n of superconducting coil assemblies. Such a rotor in this instance can in particular be designed so as to configure an electromagnetic field with n poles. The number n of poles herein can advantageously be even and be between 2 and 100, in particular between 6 and 12, and particularly advantageously be 8. In general, the advantages of the invention are particularly relevant in the case of a rotor having a comparatively high number of poles.

The superconducting coil assembly can generally comprise one or a plurality of superconducting conductors, and particularly advantageously comprise one or a plurality of superconducting tape conductors. Such a tape conductor can have a comparatively thin superconducting layer on a carrier substrate.

The superconducting conductor in general (and in particular a superconducting tape conductor) can particularly advantageously comprise a high-temperature superconducting material. High-temperature superconductors (HTS) are superconducting materials having a transition temperature above 25 K, and in some material classes, for example the cuprate superconductors, above 77 K, in which the operating temperature can be achieved by cooling with cryogenic materials other than liquid helium. HTS materials are also particularly attractive because these materials, depending on the choice of the operating temperature, can have high upper critical magnetic fields as well as high critical current densities.

The high-temperature superconductor may for example comprise magnesium diboride and/or an oxide ceramic superconductor, for example a compound of the type REBa₂Cu₃Oₓ (REBCO for short), wherein RE stands for an element of the rare earths or a mixture of such elements.

In the embodiment with a superconductive strip conductor, the conductor may in particular also be formed by a stack of multiple strip conductors lying one on top of the other and/or adjacent to one another. In this embodiment, an even higher current-carrying capability can be attained for the individual conductor turns.

In general, and independently of the specific design embodiment of the superconducting coil assembly, the advantages of the invention are particularly relevant when the superconducting conductor used has a very high current-carrying capability. A property which guides magnetic flux can be particularly readily dispensed with for the primary component part of the carrying body in the case of high current-carrying capabilities of this type. For example, the current-carrying capability of a conductor on which the coil assembly is based can be at least 100 A. Correspondingly, the nominal operating current of the coil assembly can be at least 100 A. The operating current can particularly advantageously be even at least 300 A. In order for a high operating current of this type to be achieved, a correspondingly large conductor cross section can be used, for example, this being able to be achieved, for example, by a correspondingly large conductor width (in the range of several mm) and/or by stacking a plurality of sub-conductors. This embodiment is based on the concept that it may be more favorable to use a comparatively large conductor cross section and to accept the correspondingly high costs for the superconducting material, but to instead largely dispense with structures that guide magnetic flux in the region of the carrying body and to thus achieve a lower level of complexity for the carrying body.

According to a generally advantageous embodiment of the electric machine, the latter herein can be a synchronous machine. The advantages of the invention are particularly relevant above all in the case of synchronous machines having a comparatively large diameter and/or having comparatively low rotating speeds. The weight savings in the case of the design embodiment of the rotor according to the invention are particularly large for machines of this type.

In general, the external diameter of the rotor can advantageously be in the range of 1 m or more. This external diameter in this instance corresponds substantially to the air gap diameter of the electric machine.

Alternatively or additionally, the nominal rotating speed of the machine can be 1000 revolutions per minute or less. The mechanical loads in the region of the carrying body are comparatively minor at such rather low rotating speeds, and more freedom therefore results in the choice of the materials for the carrying body.

### BRIEF DESCRIPTION OF THE DRAWINGS

The invention will be explained hereunder by means of some advantageous exemplary embodiments with reference to the appended drawings in which:

FIG. 1 shows a schematic illustration of an electric machine having a rotor and a stator in a schematic longitudinal section;

FIG. 2 shows an electric machine in the schematic cross section;

FIG. 3 shows a superconducting coil assembly 15 in a schematic perspective illustration;

FIG. 4 shows a fragment of a machine in a schematic cross-sectional illustration;

FIG. 5 and FIG. 6 show similar fragments of machines according to two further alternative embodiments; and

FIG. 7 shows a schematic perspective illustration of a superordinate cooling duct system according to a further exemplary embodiment.

### DETAILED DESCRIPTION OF INVENTION

Identical elements or elements with equivalent functions are provided with the same reference signs in the figures.

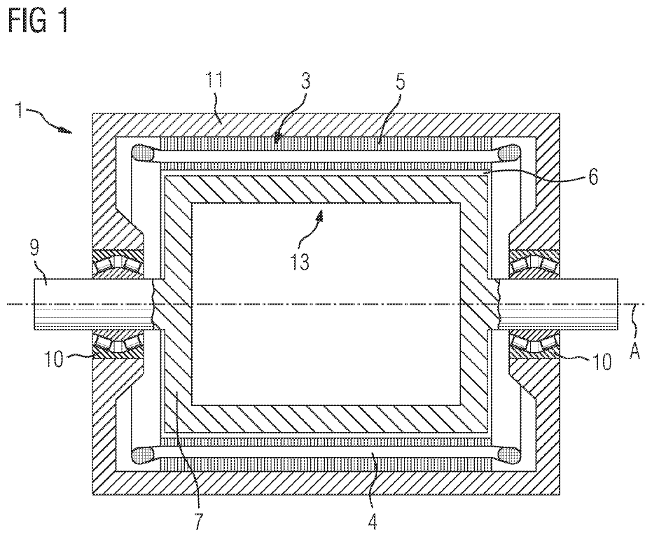

A schematic longitudinal section of an electric machine 1 along the central axis A of the machine is shown in FIG. 1. This herein is a machine according to a first exemplary embodiment of the invention. The electric machine comprises a rotor 7 and a stator 3. The rotor 7 by means of a rotor shaft 9 is mounted so as to be rotatable about a rotation axis A, the latter corresponding to the central machine axis A. To this end, the rotor shaft 7 by way of the bearings 10 is supported in relation to the machine housing 11. The electric machine can in principle be a motor or a generator, or else a machine which can be selectively operated in both modes.

The stator 3 has a plurality of stator windings 4. Above all, the axially internal regions of the stator windings 4 between the axially end-proximal coil ends interact in an electromagnetic manner with an electromagnetic field of the rotor 7 in the operation of the electric machine 1. This interaction takes place across an air gap 6 which in the radial terms lies between the rotor 7 and the stator 3. The stator windings 4 in the example shown are embedded in grooves of a stator lamination stack 5.

The electric machine of FIG. 1 in the rotor 7 has a superconducting winding having at least one superconducting coil assembly. This is advantageously a rotor winding with n poles and with n such superconducting coil assemblies. To this end, substantial parts of the rotor 7 in operation can be cooled to a cryogenic temperature which is below the transition temperature of the superconductor used. This operating temperature can be approximately 20 K, for example. The cooling can be achieved using a cooling system which is not illustrated in more detail in the image. The cryogenic components should moreover be thermally insulated in relation to the warm environment. In the exemplary embodiment shown this thermal insulation (not illustrated in more detail here) is in the external region of the rotor 7 such that the latter is thermally insulated in relation to the warm stator 3 which in radial terms lies further outside. The individual superconducting coil assemblies in the machine 1 of FIG. 1 are to be disposed on a cylindrical carrying body 13 in the radial external region of the rotor 7. Said individual superconducting coil assemblies are not plotted in FIG. 1 for reasons of clarity. The specific disposal and mechanical mounting of said individual superconducting coil assemblies is however to become evident in the context of the following figures.

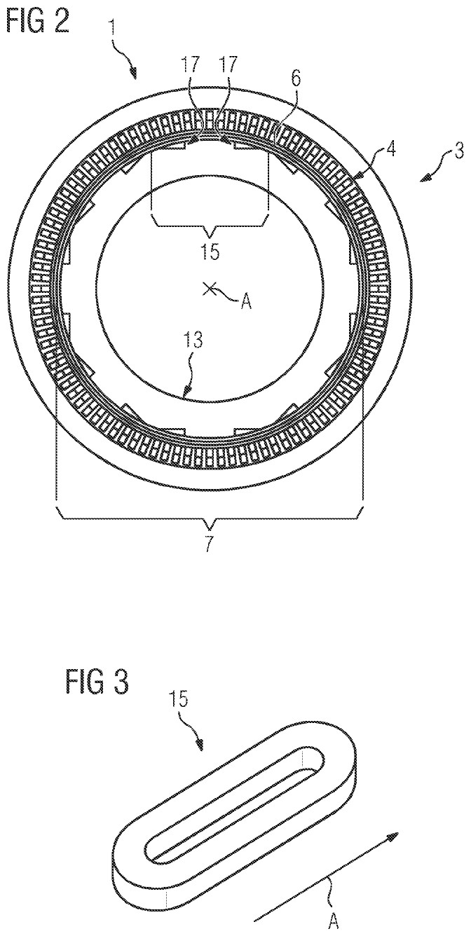

FIG. 2 shows a similar electric machine according to one exemplary embodiment of the invention in a schematic cross section, thus having a section plane which is perpendicular to the central axis A. This machine can in principle be constructed in a manner similar to the machine shown in FIG. 1. Said machine also has an external stator 3 and are radially internal rotor 7. The rotor in this example has a superconducting rotor winding with eight poles, said rotor winding comprises eight individual coil assemblies 15. Each of these coil assemblies 15 comprises two axially running conductor limbs 17 and overall configures a coil shape in the manner of a racetrack. For example, each of these coil assemblies 15 can have a basic shape in the manner of a racetrack, similar to that shown in FIG. 3. For example, each of these coil assemblies can be wound from a superconducting tape conductor and have one or a plurality of sub-coils in the form of superconducting flat coils. As is indicated in FIG. 2, each of these coil assemblies can have a step-type profile in the cross section such that the circular-cylindrical external contour of the rotor on the external side is replicated by the respective coil shape. Alternatively however, the entire coil assembly 15 can be a superordinate flat coil having two opposite planar main faces, as is illustrated in FIG. 3.

The eight coil assemblies 15 in the machine in FIG. 2 in the exemplary embodiment shown are disposed on the radially external surface of an overall cylindrical carrier body 13. This carrying body 13 is configured in the form of a hollow cylinder having an overall circular basic structure. The carrying body 13 in this exemplary embodiment is formed substantially from aluminum or an aluminum-containing alloy. Said carrying body 13 in the example shown is illustrated as an integral cylinder; alternatively however, said carrying body 13 can also be assembled from a plurality of sub-components. In order to be able to mechanically support the individual coil assemblies 15, the carrying body in the region of the external face thereof has a corresponding number of flat spots such that a planar bearing face is available for each of the coil assemblies. These bearing faces have in each case an annular basic structure which matches the shape of the coil assembly 15. A protrusion which in the manner of a coil core fills the internal part of the respective coil assembly and thus mechanically supports the latter from the inside herein is formed from the material of the carrying body 13 in the interior of the respective ring.

The material of the carrying body 13 is chosen such that the carrying body in mechanical terms is sufficiently strong, such that said carrying body has a comparatively minor density, and that the individual coil assemblies 15 in thermal terms are sufficiently well coupled to a cooling system which is not illustrated in more detail here. On account of being coupled to the cooling system, the carrying body 13 per se is also at a cryogenic temperature level. The cooling of the individual coil assemblies is facilitated by the thermal conductivity of the material of the carrying body 13. To this end, the carrying body 13 can optionally have one or a plurality of cooling ducts through which a fluid coolant can flow. These coolant ducts are not explicitly illustrated in FIG. 2 but will still be described in more detail in the context of the following examples.

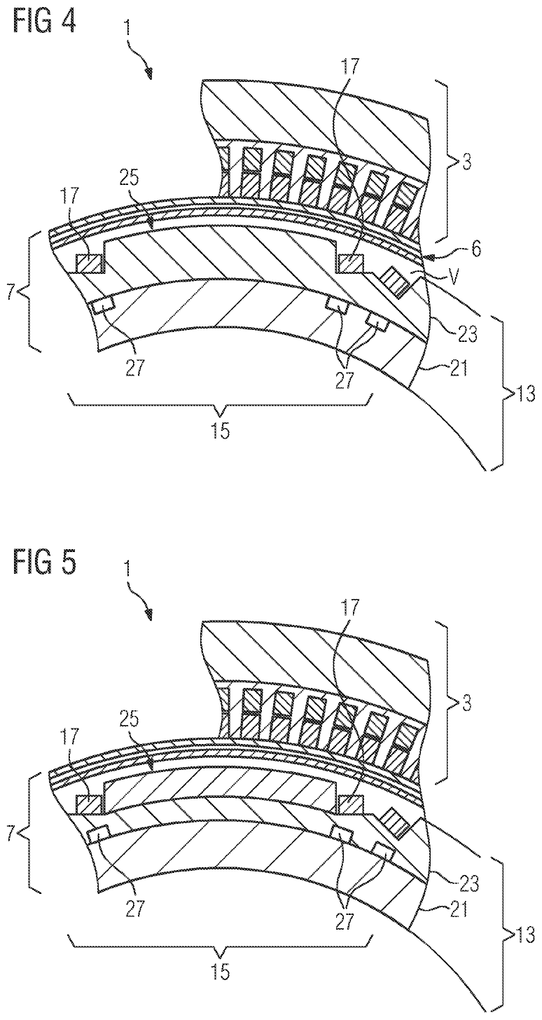

FIG. 4 thus shows a partial view of a rotor 7 according to a further exemplary embodiment of the invention, likewise in a schematic cross section. A small sub-portion of the stator 3 as well as the air gap 6 between the rotor and the stator are likewise illustrated in FIG. 4. Shown in terms of the rotor 7 is the fragment in the region of approximately one magnetic pole, thus the region of a complete coil assembly 15 having the two axial limbs thereof. Furthermore, another individual axial limb of an adjacent coil assembly is shown. The individual coil assemblies 15 here too are disposed on the external side of the cylindrical carrying body 13. Each of the coil assemblies 15 herein is configured as a flat coil in the manner of a racetrack, wherein each of the axial coil limbs has a rectangular cross section. The radially internal surface of the respective coil assembly 5 herein mechanically contacts a matching planar bearing face on the radially external side of the cylindrical carrying body 13. These planar bearing faces in turn are in each case configured as flat spots of the circular-cylindrical basic body. The carrying body 13 in the example of FIG. 4 is formed by two cylindrical bodies which are nested inside one another, specifically an inner cylinder 21 and an outer cylinder 23. The outer cylinder 23 herein, besides the flat spots for the bearing faces of the coil assemblies, also has a plurality of protrusions 25 which in the manner of a coil core fill in each case the internal region of the individual flat coils in the manner of racetracks. The cylindrical inner cylinder 21 and the cylindrical outer cylinder 23 are nested in one another in a substantially exact fit. Said inner cylinder 21 and said outer cylinder 23 are made as individual components but may thereafter have been fixedly connected to one another in mechanical terms. One or a plurality of recesses by way of which coolant ducts for the flow of fluid coolant are defined can be provided in one of the two cylinders, or else in both cylinders, in the region of the contact face between said cylinders. In the example of FIG. 4, such coolant ducts 27 are formed by corresponding recesses on the external face of the inner cylinder 21, for example. Alternatively or additionally, said coolant ducts 27 can also be formed by similar recesses on the internal face of the external cylinder 23. The individual duct segments 27 in the example of FIG. 4 advantageously run at a relatively minor spacing from the coil limbs 17 so as to be able to cool the latter as effectively as possible. The duct segments 27 shown here are correspondingly duct segments which are aligned in the axial direction. The superordinate duct system within the entire carrying body 13 branches such that the coolant can flow in parallel through the individual duct segments 27. Alternatively or additionally, a serial flow of coolant through individual such axial segments can in principle also be implemented. It is essential merely that a transport of coolant through the ducts (according to a closed or else an open circuit) is affected by means of a superordinate cooling system, and the coil assemblies 15 are thus effectively cooled to a cryogenic temperature by way of the comparatively positive thermal conductivity of the carrying body 13. The embodiment shown, having two sub-cylinders which are pushed inside one another, enables such a cooling duct system to be configured in a simple manner.

In the machine according to the exemplary embodiment of FIG. 4 the carrying body 13 is at a cryogenic operating temperature while the radially external stator 3 is operated at a significantly higher temperature. In order for the thermal insulation required for that purpose to be guaranteed, a vacuum chamber V is situated in the region between the carrying body 13 and the stator 3. In order for the configuration a sufficiently good vacuum to be enabled here, this vacuum chamber V has to be sufficiently sealed in relation to the coolant chamber within the coolant ducts 27. In the example of FIG. 4, this sealing is guaranteed by the carrying body per se and here in particular on account of the outer cylinder 23.

As an alternative to the embodiment having two sub-cylinders illustrated in FIG. 4, the carrying body 13 can in principle also be configured in an overall integral manner, and similar coolant ducts 27 can be embedded in the interior of the cylinder wall. Such a structure can be formed by an additive manufacturing method, for example.

In the example of FIG. 4, the inner cylinder 21 and the outer cylinder 23 can in each case be formed from a homogenous non-magnetic material having the properties stated further above in terms of density and thermal conductivity. Here too, this can again be aluminum, an aluminum alloy, or a fiber-reinforced composite material, for example. Guiding of the magnetic flux through the carrying body is not necessarily required by virtue of the high current-carrying capability in the superconducting conductors of the individual coil assemblies 15. Accordingly, the carrying body in this instance can be of a comparatively simple construction and be embodied so as to be correspondingly light.

A similar sub-region of the electric machine 1 according to a further exemplary embodiment of the invention is shown in FIG. 5. In a manner similar to the example of FIG. 4, the carrying body 13 here too is assembled from an inner cylinder 21 and an outer cylinder 23. Here too, a plurality of duct segments 27 are formed between these two sub-cylinders, said duct segments 27 in this case being formed by corresponding recesses in the outer cylinder 23, for example. The outer cylinder 23 here too, besides the flat spots for the contact faces of the coil assemblies, has a corresponding number of protrusions 25 which fill in each case the internal regions of the coil assemblies 15. By contrast to the preceding example, these protrusions 25 here are however formed from a ferromagnetic material. In a manner analogous to the preceding example, the inner cylinder 21 and the outer cylinder 23 are again in each case formed from a non-magnetic material having the mentioned further properties. The two cylinders 21 and 23 conjointly form the major proportion of material of the entire carrying body 13. Therefore, the entire carrying body 13 here too is formed largely from non-magnetic material. The ferromagnetic protrusions 25 which are additionally present in this hybrid form serve for additional guiding of the magnetic flux in the region of the local coil cores. The flux chain between the rotor 7 and the stator 3 can be even further improved on account of said protrusions 25. In the context of the present invention it is essential merely that the carrying body 13 in its majority is formed from non-magnetic material and that there is contact with non-magnetic material in particular in the region of the radially internal bearing faces for the coil assemblies. Here too, it is this non-magnetic material (specifically the non-magnetic material of the outer cylinder 23) which facilitates the thermal coupling of the coil assemblies 15 to the coolant flowing in the individual cooling ducts 27.

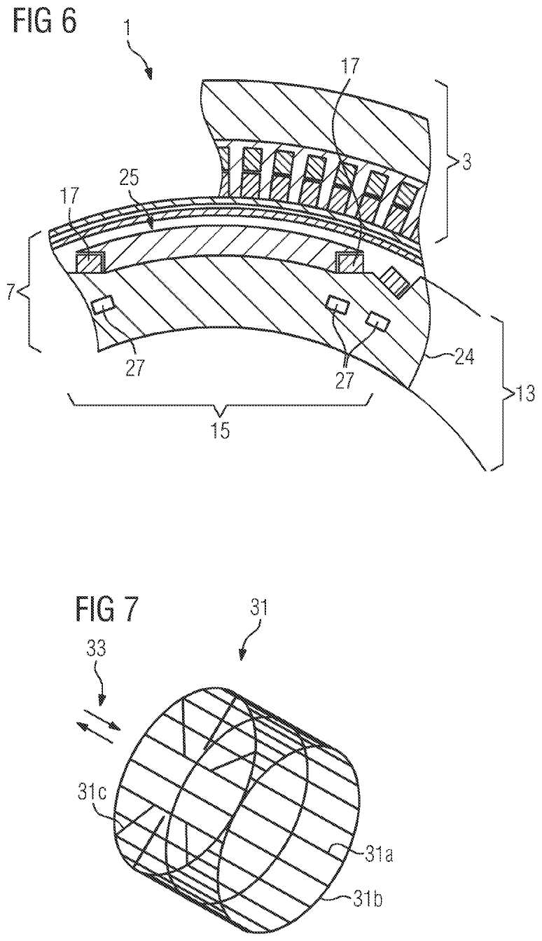

A similar sub-region of an electric machine 1 according to a further exemplary embodiment of the invention is shown in FIG. 6. As opposed to the preceding examples, the carrying body 13 here has only a single carrying cylinder 24 as a substantial load-bearing element for the coil assemblies. Here too, this carrying cylinder is formed from a corresponding non-magnetic material having the additional properties described further above. The carrying cylinder 24 in this example has been produced by an additive manufacturing method, and a plurality of cooling duct segments 27 are embedded in the interior of this cylinder. Here too, the individual duct segments are situated in the proximity of the coil limbs to be cooled such that the latter can be effectively cooled.

In a manner similar to the preceding example, the non-magnetic carrying cylinder 24 here too on the radial external side thereof is provided with a plurality of protrusions 25 from ferromagnetic material. Here too, each of the present coil assemblies in the interior thereof is in each case filled by such a ferromagnetic protrusion 25. As opposed to the preceding example, these ferromagnetic protrusions 25 for improved guiding of the flux additionally have roof-type overhangs 26 which according to the principle of a salient pole further amplify the guiding of flux between the rotor and the stator.

FIG. 7 shows a schematic perspective illustration of the superordinate cooling duct system 31 such as can be used in various embodiments of the electric machine in the interior of the carrying body 13. Such a cooling duct system can be implemented as has been described above, either by corresponding recesses between two cylinders which are pushed inside one another, or else by an additive manufacturing method within an integral cylinder. The cooling duct system 31 illustrated has a type of cylindrical cage structure. Said cooling duct system 31 comprises a plurality of dissimilar duct segments through which the cryogenic coolant can be distributed such that the latter in the various regions of the rotor can in each case reach the proximity of the individual coil assemblies. The cooling duct system illustrated here overall comprises a plurality of axial duct segments 31a as well as a plurality of annular duct segments 31b which extend in the circumferential direction, as well as a plurality of radial duct segments 31c. This superordinate duct system 31 can be supplied with a fluid cryogenic coolant by means of a central inflow and outflow 33 which are not illustrated in more detail here. In principle, either a common inflow and outflow is possible herein, or else an inflow and an outflow in separate configurations. For example, a common inflow and outflow can be formed in the central region of the rotor shaft, and the cryogenic coolant overall can circulate through the cage structure in the manner of a thermosiphon, and reach the direct proximity of the individual coil assemblies of the rotor through the corresponding branches and the plurality of segments running in parallel (in particular the parallel axial segments 31a).

1.-15. (canceled)

16. A rotor for an electric machine having a central rotor axis, comprising:
at least one superconducting coil assembly;
a cooling system for cooling the coil assembly to a cryogenic operating temperature; and
a carrying body which from a radially inward side of the coil assembly mechanically supports the at least one coil assembly;
wherein the carrying body has a substantially cylindrical external contour;
wherein the carrying body is composed largely of a non-magnetic material which has a density of at most 4.6 g/cm3 and a thermal conductivity of at least 10 W/(m-K);
wherein the carrying body is designed for thermally coupling the superconducting coil assembly to the cooling system; and
wherein the carrying body has an inner cylinder and an outer cylinder, wherein the outer cylinder radially surrounds the inner cylinder and on the external side of the former mechanically supports the at least one coil assembly.

17. The rotor as claimed in claim 16,
wherein the non-magnetic material of the carrying body comprises aluminum.

18. The rotor as claimed in claim 16,
wherein the non-magnetic material of the carrying body comprises a fiber-composite material.

19. The rotor as claimed in claim 16,
wherein the carrying body when operating the rotor is designed to be at a cryogenic operating temperature.

20. The rotor as claimed in claim 16,
wherein the carrying body comprises at least one coolant duct embedded in the former for transporting a fluid coolant.

21. The rotor as claimed in claim 16,
wherein the carrying body in the region of the cylindrical external contour thereof is designed so as to be fluid-tight.

22. The rotor as claimed in claim 16,
wherein at least one coolant duct in the contact region between the inner cylinder and the outer cylinder is formed by at least one elongate recess in the inner cylinder and/or in the outer cylinder.

23. The rotor as claimed in claim 16,
wherein the carrying body is produced by an additive manufacturing process.

24. The rotor as claimed in claim 16,
wherein the carrying body in addition to the mentioned non-magnetic material has a comparatively minor proportion of a ferromagnetic material.

25. The rotor as claimed in claim 16,
wherein the carrying body as a sub-face of the external face thereof has at least one radially external bearing face on which the at least one coil assembly is mechanically held.

26. The rotor as claimed in claim 16,
said rotor having a plurality of superconducting coil assemblies.

27. An electric machine, comprising:
a rotor as claimed in claim 16, and
a stator which is disposed so as to be stationary.

28. The electric machine as claimed in claim 27,
wherein the external diameter of the rotor is at least 1 m.

29. The electric machine as claimed in claim 27,
said electric machine being adapted for a rotating speed of the rotor of 1000 revolutions per minute or less.
